(19) United States
(12) Patent Application Publication
(10) Pub. No.: US 2025/0037211 A1
(43) Pub. Date: Jan. 30, 2025

(54) Social Media Networking System And Method

(71) Applicants: Niten Luthra, Granite Bay, CA (US); Lina Trivedi, Beaver Dam, WI (US)

(72) Inventors: Niten Luthra, Granite Bay, CA (US); Lina Trivedi, Beaver Dam, WI (US)

(21) Appl. No.: 18/757,969

(22) Filed: Jun. 28, 2024

Related U.S. Application Data
(60) Provisional application No. 63/524,497, filed on Jun. 30, 2023.

(51) Int. Cl. G06Q 50/00; G06Q 30/0251

(52) U.S. Cl. CPC G06Q 50/01; G06Q 30/0255

(57) ABSTRACT

A social media network and a method of generating communication on the social media network are provided. The social media network includes digital clones generated in response to characteristics provided by corresponding associated users of the social media network. Each digital clone is associated with a corresponding user device. Dialogue is generated between first and second digital clones and provided on first and second user devices. Users of the first and second user devices are allowed to interject comments into the dialogue. Trends and patterns in the dialogue and interjections are identified so as to enhance the dialogue and to allow each digital clone to be updated in real time.

### FIELD OF THE INVENTION

This invention relates generally to social media networks, and in particular, to a social media network system and method wherein a digital clone established by a user of the social network is created for communication with other digital clones established by users of the social media network to facilitate social connections and provide metrics on the emotional and/or physical health of those social connections.

### BACKGROUND AND SUMMARY OF THE INVENTION

As is known, social media networks are virtual communities wherein users to track and establish connections with others such as people, businesses, and other entities, to allow for the communication of information between users. Social media networks can vary in format and features to effectuate the primary purposes thereof. For example, social media networks may be designed to allow users to interact with real-life friends, to meet new people for friendship or romance, to sell products, or to spread news and information. Further, most social media networks allow users to utilize various types of devices such as desktops, laptops, tablets and smartphones to communicate, thereby simplifying and encouraging users to continually utilize the social media network for their ongoing interactions with others.

While functional for their intended purpose, these prior systems are limited. For example, most social media networks merely allow users to communicate with each other and are almost entirely dependent on a user's initiative to socially connect. Further, these prior social media networks provide no mechanisms to foster or cultivate friendships between users or to facilitate the users meeting in person or becoming closer romantically. In other words, the current social media networks merely act as intermediaries passing communications between parties. As such, there exists a longfelt need to provide a social media network that actively initiates conversations and banter between users to enhance and encourage human-to-human communication and to address deficiencies that exist with the mere transmission of communications between various individuals, business or the like.

Therefore, it is a primary object and feature of the present invention to provide a social media network system and method wherein a digital clone established by a user of the social network is created for communication with other digital clones established by users of the social media network to facilitate social connections

It is a further object and feature of the present invention to provide a social media network system and method which utilizes patterns, trends, correlations and/or clusters within data provided by a user to create a digital clone of a user.

It is a still object and feature of the present invention to provide a social media network system and method which utilizes patterns, trends, correlations and/or clusters within data to enhance a dialogue between various digital clones established by users to facilitate real world communication between the users.

In accordance with the present invention, a social media network is provided. The social media network includes a cloud-based control system and a plurality of user devices. Each of the plurality of user devices has a corresponding user associated therewith, is communicable with the server and with the other of the plurality of user devices through the cloud-based control system, and has device controller. The device controller is configured to receive a first set of input data from an associated user, ransmit a first set of input data to the cloud-based control system, and transmit a second set of input data to one of more of the other of the plurality of user devices through the cloud-based control system. The second sets of data transmitted are defined as a dialogue between the plurality of users devices. A cloud controller is associated with the cloud-based control system. The cloud controller is configured to receive the first and second sets of input data from each of the plurality of user devices, automatically identify and evaluate data in the first sets of input data received from the plurality of user devices, and generate a digital clone for each associated user in response to the first set of input data received from a corresponding one of the plurality of user devices. Each digital clone has a unique set of characteristics corresponding to the first set of input data. The cloud controller is configured to transmit each digital clone to a corresponding one of the plurality of user devices of the associated user.

The digital controller of each of the plurality of user devices is further configured to receive the digital clone from the cloud controller for the associated user, generate the second set of input data dependent upon the set of characteristics of the digital clone of the associated user of the user device, and automatically transmit the second set of input data to the cloud controller. Each user device includes a display. The display of each of the plurality of user devices is configured to display the second set of input data transmitted by the user device.

The cloud controller is further configured to transmit the second set of input data from a first user device to a second user device. The digital controller of the second user device configured to generate a corresponding second set of input data dependent upon the set of characteristics of the digital clone of the associated user of the second user device and automatically transmit the second set of input data to the cloud controller.

The cloud controller transmits the second set of input data received from the second user device to the first user device. The display of the first user device displaying the second set of input data received by the first user device.

The digital controller of the first user device receives a first set of injection data from an associated user and transmit the set of injection data to the cloud-based control system. The cloud controller transmits the set of injection data received from the first user device to the second user device. The display of the second device displaying the set of injection data received by the second user device.

In accordance with a further aspect of the present invention, a method is provided for generating communication on a social media network. The method includes the step of generating digital clones in response to characteristics provided by corresponding associated users of the social media network. Each digital clone is associated with a corresponding user device. Dialogue between first and second digital clones is generated. The dialogue is provided on first and second user devices. Users of the first and second user devices are allowed to interject comments into the dialogue.

The step of generating digital clones may include the additional steps of receiving information from each user and generating a unique digital clone for each user. The step of generating dialogue between first and second digital clones may include the additional step of matching the first and second digital clones based on the information used to form the first and second digital clones. Alternatively, the first and second digital clones may be matched randomly. At least one of the users of the first and second user devices may be prompted to interject comments into the dialogue. In addition, an advertisement may be injected into the dialogue between the first and second digital clones. The dialogue between the first and second digital clones may be monitored to identify and evaluate the interest of users of the first and second user devices in the advertisement prior to interjecting the advertisement in the dialogue.

In accordance with a still further aspect of the present invention, a method of generating communication on a social media network is provided. The method includes the step of gathering information on characteristics of a plurality of users. Each user is associated with a user device. Unique digital clones are generated in response to the characteristics gathered. Each digital clone is associated with a corresponding user. Each digital clone is uploaded to a corresponding user device. Each digital clone and the corresponding user device are associated with a common user. First and second digital clones are selected for interaction between the first and second digital clones. Dialogue is generated between the first and second digital clones. The dialogue is provided on first and second user devices.

Users of the first and second user devices are allowed to interject comments into the dialogue. The comments injected into the dialogue may be evaluated and the dialogue between the first and second digital clones may be modified in response to the evaluation of the comments. In addition, the step of generating dialogue between first and second digital clones may include the additional steps of evaluating the characteristics used to generate the first and second digital clones and generating dialogue between the first and second digital clones in response to the evaluation of the characteristics used to generate the first and second digital clones. Alternatively, the first and second digital clones may be matched randomly.

At least one of the users of the first and second user devices may be prompted to interject comments into the dialogue. In addition, an advertisement may be injected into the dialogue between the first and second digital clones. The characteristics used to generate the first and second digital clones may be evaluated to determine an interest of the users of the first and second user devices in the advertisement prior to interjecting the advertisement in the dialogue. The advertisement may be modified in response to the evaluation of the characteristics.

### BRIEF DESCRIPTION OF THE DRAWINGS

Preferred exemplary embodiments of the invention are illustrated in the accompanying drawings in which like reference numerals represent like parts throughout, and in which:

FIG. 1 is a schematic representation of a flow of data in a social media network system in accordance with the present invention;

FIG. 1B is a schematic representation of the components of the social media network system of the present invention;

FIG. 2 is a schematic illustration of a dialogue box used to gather a user's preferences and style to generate a digital clone of the user for the social media network system of the present invention;

FIG. 3 is a schematic illustration of a flowchart depicting the flow of data corresponding to the gathering of a user's preferences and style in the social media network system of the present invention; and

FIG. 4 is a schematic illustration of the organization of a dialogue library stored in computer memory of the social media network system of the present invention;

FIG. 5 is a schematic illustration of a dialogue between digital clones on the social media networking system of the present invention; and

FIG. 6 is a schematic illustration depicting interjection of a user into the dialogue between digital clones on the social media networking system of the present invention.

### DETAILED DESCRIPTION OF THE DRAWINGS

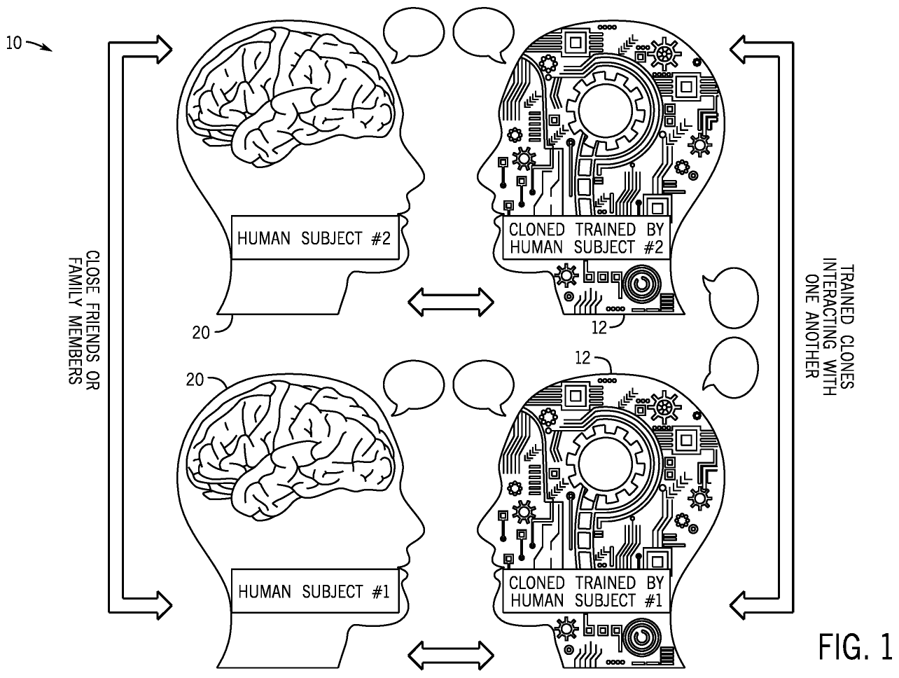

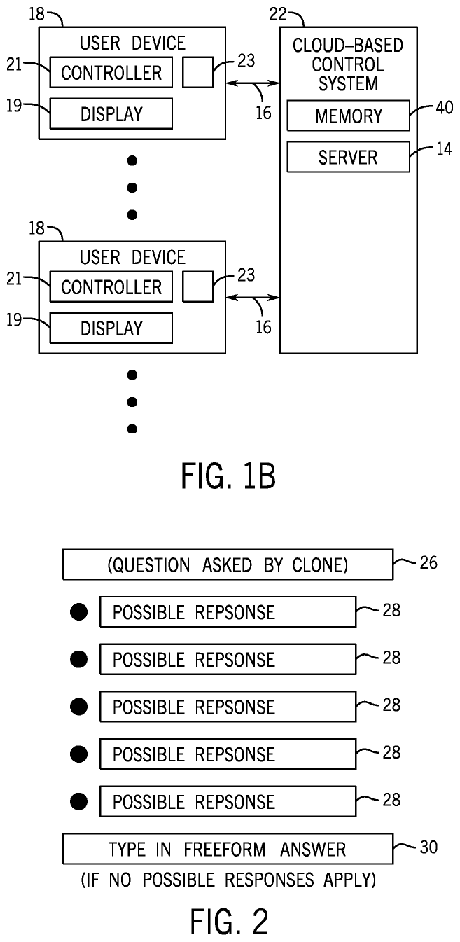

Referring to FIGS. 1-6, a social media network system in accordance with the present invention is generally designated by the reference numeral 10. It is intended for social media network system 10 to provide an environment wherein digital clones 12 of human subjects or users 20 are created for communication over social media network system 10. Each digital clone 12 is created, and thereafter, updated in real-time in response to data and behaviors supplied by a user, e.g., real-time choices made by a user, language patterns of a user, preferences selected by a user, behavioral trends of the user, and the user's decision making processes.

Social media network system 10 includes a cloud-based control system 22 comprising a server 14 in communication with various user device(s) 18 over a communications network 16. Server 14 includes memory and can include or be coupled to a microprocessor, a microcontroller or other programmable logic element (individually and collectively considered “a controller”) configured to execute a program, including an AI (artificial intelligence) algorithm to effectuate the methodology of the present invention, as hereinafter described. The AI algorithm allows server 14 to utilize the data received to identify patterns, trends, correlations and/or clusters within the data to learn and make decisions without explicit programming. More specifically, it is intended for the AI algorithm to automatically identify and evaluate patterns and trends provided by a user to create digital clone 12, as hereinafter described.

User devices 18 may take the form of a smart phone, tablet, laptop, or personal computer and may communicate with cloud-based control system 22 over a cellular network or the internet via an internet provider, thereby allowing users 20 of social media network system 10 to interact with server 14 of cloud-based control system 22 and other users 20, as hereinafter described. It is contemplated for each user device 18 to include a display system 19 that typically includes both an audio display and a video display, such as a touch screen. Each user device 18 also has a controller/processor 21 to allow for internal computing capabilities, computer-readable memory and, in the case of a smart phone or tablet, a program or software application serving as a user interface with the social media network system 10. Similar to cloud-based control system 22, each user device 18 may include an AI (artificial intelligence) algorithm stored thereon to effectuate the methodology of the present invention. The AI algorithm allows the controller of each user device 18 to identify patterns, trends, correlations and/or clusters within the data provided by a user 20 to enhance digital clone 12, as hereinafter described.

Each user device 18 further includes at least one actuatable user input 23, such as all or a portion of the touch screen, a keypad, and/or a microphone. In response to the information provided on the display of the one or more user devices 18, a user may actuate at least one actuatable user input to address and input information via the social media network system 10.

In order for a user to join the social media network system, a user 20 must first establish an account with the social media provider through the social media provider's webpage or using the social media provider's application on user device 18, as heretofore described. Once user 20 establishes an account, either through the social media provider's webpage or the software application, user 20 is presented with a series of questions 26 that relate to personal preferences, FIG. 2. The questions presented are directed towards a user's preferences and style in areas such as food, sports, family relations, music, hobbies, politics, religion, work, school, geographical location, and the like. Questions are presented either through social media provider's webpage, social application or directly via user device 18. User 20 is prompted to answer each question on social media provider's webpage or social application through either one of a plurality of pre-filled options 28, a predictive or freeform input 30 or a combination thereof for transmission to server 14 of cloud-based control system 22 over communications network 16.

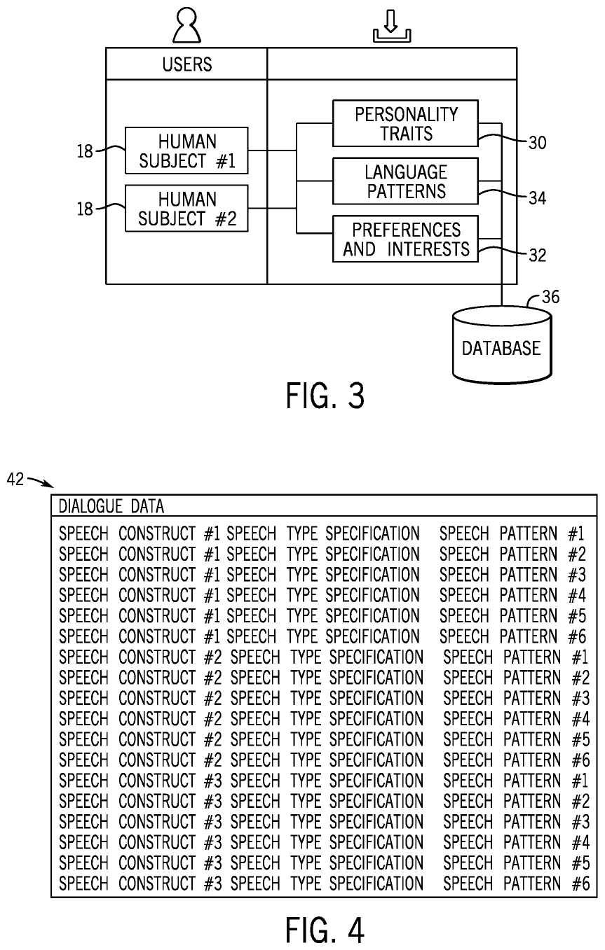

Once user 20 answers the series of questions, the response to the questions are uploaded to the server 14 of cloud-based control system 22 over communications network 16 wherein the data corresponding to the responses is compiled to organize the data in accordance with the user's personality traits 30, preferences 32 and dialogue patterns 34, FIG. 3. Alternatively, user 20 may answer each question and transmit the answers to server 14 of cloud-based control system 22 via Short Message Service (SMS) text messaging or via a chat interface provided through the social media provider's webpage or the social application wherein the data corresponding to the responses is compiled to organize the data in accordance with the user's personality traits 30, preferences 32 and dialogue patterns 34, FIG. 3. The compiled data is stored in database 36 and associated with user 20. In addition, the AI algorithm of cloud-based control system 22 utilizes the compiled data to identify patterns, trends, correlations and/or clusters within the data to generate digital clone 22 associated with user 20, which may be uploaded to a corresponding user device 18 over communications network 16, for reasons hereinafter described.

In order to encourage responses from user 20, a gamification model may be implemented on social media network 10 to establish levels and privilege incentives within the software application. User 20 advances levels in this gamification model by engaging in higher frequency or with specifically requested information by digital clone 12. A minimum level in the gamification model is required for digital clone 12 to interact with other user's digital clones 20.

Server 14 of cloud-based control system 10 further includes a dialogue library stored in computer memory 40 that stores typical patterns of speech 42 as it relates to human dialogue, FIG. 4. More specifically, the dialogue library contains patterns of general communication that relate to initiating conversation, banter and advancing interests in order to fuel a new language model. The language model will be updated through extended audio exchanges and/or SMS text exchanges between cloud-based control system 22 and user 20 via user device 18 in order to facilitate the creation of digital clone 12 by the AI algorithm that reflects the language patterns of user 20. This process, in turn, produces a dynamic language model that will offer variances in speech pattern in order to emulate the speech patterns of each individual user.

In operation, user 20 logs into their account with the social media provider through the social media provider's webpage or using the social media provider's application on user device 18, or via direct communication through user device 18. User 20 may log into the social media network system 10 at their discretion in order to communicate with digital clones 12 of other users 20 in order to connect and establish social connections, as hereinafter described.

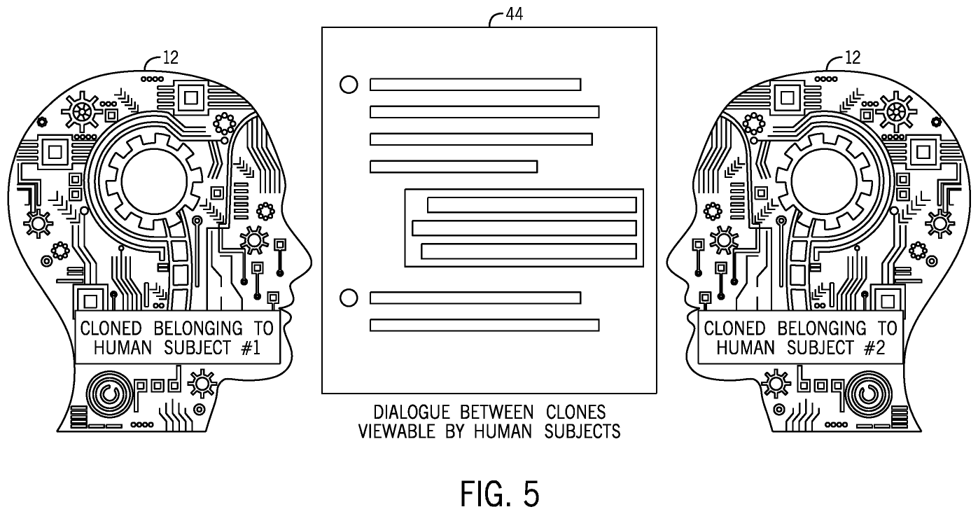

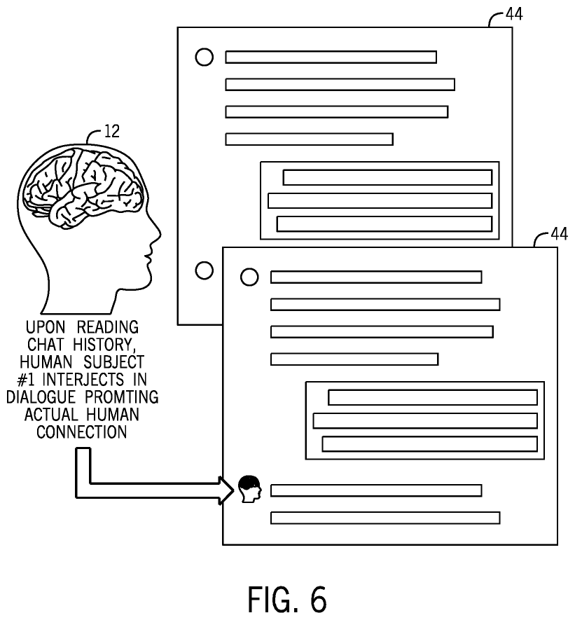

Once a user is logged into their account, the AI algorithm on user device 18 utilizes the user's personal preferences and style in areas such as food, sports, family relations, music, hobbies, politics, religion, work, school, geographical location, and the like, in conjunction with the dialogue library, to produce dialogue 44 for digital clone 12 of user 20 to interact with other users 20 on the social media network system 10 towards a tangible engagement. User 20 may establish a dialogue through user device 18, via cloud-based control system 22, with digital clones 12 of user devices 18 of specific users 20, with digital clones 12 of user devices 18 of users 20 already logged into the social media network system 10, with digital clones 12 of user devices 18 assigned by server 14 based on comparison of predetermined factors to ensure compatibility, e.g. similar interests or geographical locations, or with digital clones 12 of user devices 18 of users 20 or group of users 20 logged into the social media network system 10 and randomly assigned by server 14. The dialogue 44 produced by digital clones 12 of users 20 may be audible or visible as text on the user devices 18, FIG. 5, and is configured such that either of the users 20 can override the conversation and interject in the dialogue exchange, in order to communicate to the other user 20 or groups of users 20 directly, FIG. 6.

Utilizing the user's personal preferences and style in areas such as food, sports, family relations, music, hobbies, politics, religion, work, school, geographical location, and the like, the AI algorithm on user device 18 continues to utilize digital clone 12 to initiate conversations, banter, and interject with actionable items in order to set the next stage of conversation. The spirit of this technology is to enhance human-to-human communication in order to address deficiencies that exist with human connection. For example, communication between the digital clones 12 may be used to:
Foster or cultivate friendships
Meet friends in person or virtually
Become closer romantically.
Collaborate on art projects
Compete in team sports or fandoms.
Produce community events
Develop potential employment opportunities.
Foster relationships with a business team environment

Also, it is contemplated for the AI algorithm on user device 18 to monitor the communications of each digital clone 12 and the interjections into the dialogues by users 20. The AI algorithm on user device 18 is configured to evaluate and identify trends and patterns in the communications and interjections so as update personality traits 30, preferences 32 and dialogue patterns 34 of each digital clone 12 in real time. It is intended for each digital clone 12 to have a profile which accurately represents the essence of its associated user. For example, the factors the AI algorithm on user device 18 will consider when updating each digital clone 12 may include, but are not limited to:
Tracking of mood fluctuations of the user.
Physical health status
Openness to connect.
Sentiment towards life.
Level of optimism
· Age, location, friends and family connections
Pets
Sexual orientation
Personality attributes
Values
Lifestyle and Habits

In order to allow users 20 to understand the emotional deficiencies that are identified through interaction between digital clones 12, a score card will be presented and accessible in social media network 10. For example, a low cognitive visual display may be provided to reflect the emotional and/or physical health of users 20 through colors representing various levels of emotional health. The scoring can change through the gaming mechanism established to encourage the dialogue between digital clones 12, and hence, users 20. Further, the score card may present information regarding a user's:
Key activities
Key challenges
Overall sentiment including stress levels, physical health status, overall attitude towards life and willingness to connect
Detailed instances of what causes user 20 to feel joy, happiness, peace or gratitude.

As dialogue 44 progresses, the AI algorithm of server 14 may prompt other users 20 to join into the discussion directly through the social media provider's webpage or using the social media provider's application on user devices 18, or via direct communication through user devices 18. In addition, server 14 may prompt user 20 directly through the social media provider's webpage, the social media provider's application on user device 18, or via direct communication through user device 18 to contact other users 20 directly outside the social media network system 10, such as via text, phone call or in-person. Further, it is contemplated for server 14 to monitor the dialogue between digital clones 12 and the interjection in those dialogue exchanges by user 20 to further enhance the digital clone 12 of a user 20 to better encourage the user 20 to interject/participate in the dialogue 44. For example, as the digital clones 12 interact, it is contemplated for server 14 to deliver/upload non-intrusive ads to the users 20. More specifically, server 14 may provide instructions to user device 18 causing digital clone 12 of user 20 to ask user 20 one or more questions in an attempt to engage in the user 20 in a dialogue to determine whether the ads are welcomed by the user. Thereafter, the AI algorithm on user device 18 may continually update digital clone 12 of user 20 in response to the dialogue between the digital clone 12 and user 20 and advise server 14 accordingly. In such manner, it can be appreciated that any ads delivered by server 14 to user 20 will be very relevant to user 20. By way of example, it is contemplated for an ad delivery to begin with a dialogue from the digital clone 12 to the user 20 to determine if the user 20 would be interested in the advertisement, as opposed to current models where users 20 are exposed to advertisements as a gateway between themselves and the content they are pursuing. In the dialoging process, the AI algorithm on user device 18 will make an assessment if the ad delivery would be appropriate based on the user's response, and the data already stored on users 20 based on past interactions with digital clone 12.

Although the best mode contemplated by the inventors of carrying out the present invention is disclosed above, practice of the above invention is not limited thereto. It will be manifest that various additions, modifications and rearrangements of the features of the present invention may be made without deviating from the spirit and the scope of the underlying inventive concept.

We claim:

1. A social media network, comprising:
a cloud-based control system; and
a plurality of user devices, each of the plurality of user devices:
having a corresponding user associated therewith;
communicable with the server and with the other of the plurality of user
devices through the cloud-based control system; and
having a device controller being configured to:
receive a first set of input data from an associated user;
transmit a first set of input data to the cloud-based control system; and
transmit a second set of input data to one of more of the other of the plurality of user devices through the cloud-based control system, the second sets of data transmitted being defined as a dialogue between the plurality of users devices;
a cloud controller associated with the cloud-based control system and being configured to:
receive the first and second sets of input data from each of the plurality of user devices;
automatically identify and evaluate data in the first sets of input data received from the plurality of user devices;
generate a digital clone for each associated user in response to the first set of input data received from a corresponding one of the plurality of user devices, each digital clone having a unique set of characteristics corresponding to the first set of input data; and
transmit each digital clone to a corresponding one of the plurality of user devices of the associated user.

2. The social media network of claim 1 wherein the digital controller of each of the plurality of user devices is configured to:
receive the digital clone from the cloud controller for the associated user; and
generate the second set of input data dependent upon the set of characteristics of the digital clone of the associated user of the user device; and
automatically transmit the second set of input data to the cloud controller.

3. The social media network of claim 2 wherein each user device includes a display, the display of each of the plurality of user devices configured to display the second set of input data transmitted by the user device.

4. The social media network of claim 3 wherein the cloud controller is configured to transmit the second set of input data from a first user device to a second user device, the digital controller of the second user device configured to:
generate a corresponding second set of input data dependent upon the set of characteristics of the digital clone of the associated user of the second user device; and
automatically transmit the second set of input data to the cloud controller.

5. The social media network of claim 4 wherein the cloud controller is configured to transmit the second set of input data received from the second user device to the first user device, the display of the first user device displaying the second set of input data received by the first user device.

6. The social media network of claim 5 wherein the digital controller of the first user device is configured to:
receive a first set of injection data from an associated user; and
transmit the set of injection data to the cloud-based control system.

7. The social media network of claim 6 wherein the cloud controller is configured to transmit the set of injection data received from the first user device to the second user device, and the display of the second device displaying the set of injection data received by the second user device.

8. A method of generating communication on a social media network, comprising the steps of:
generating digital clones in response to characteristics provided by corresponding associated users of the social media network, each digital clone associated with a corresponding user device;
generating dialogue between first and second digital clones, the dialogue being provided on first and second user devices; and
allowing users of the first and second user devices to interject comments into the dialogue.

9. The method of claim 8 wherein the step of generating digital clones includes the additional steps of:
receiving information from each user; and
generating a unique digital clone for each user.

10. The method of claim 9 wherein the step of generating dialogue between first and second digital clones includes the additional step of matching the first and second digital clones based on the information used to form the first and second digital clones.

11. The method of claim 9 wherein the step of generating dialogue between first and second digital clones includes the additional step of matching the first and second digital clones randomly.

12. The method of claim 8 comprising the additional step of prompting at least one of the users of the first and second user devices to interject comments into the dialogue.

13. The method of claim 8 comprising the additional step of interjecting an advertisement into the dialogue between the first and second digital clones.

14. The method of claim 13 comprising the additional step of monitoring the dialogue between the first and second digital clones to identify and evaluate the interest of users of the first and second user devices in the advertisement prior to interjecting the advertisement in the dialogue.

15. A method of generating communication on a social media network, comprising the steps of:
gathering information on characteristics of a plurality of users, each user associated with a user device;
generating unique digital clones in response to the characteristics gathered, each digital clone associated with a corresponding user;
uploading each digital clone to a corresponding user device, each digital clone and the corresponding user device being associated with a common user;
selecting first and second digital clones for interaction therebetween; and
generating dialogue between the first and second digital clones, the dialogue being provided on first and second user devices.

16. The method of claim 15 further comprising the step of allowing users of the first and second user devices to interject comments into the dialogue.

17. The method of claim 16 comprising the additional step of evaluating the comments injected into the dialogue and modifying the dialogue between the first and second digital clones in response to the evaluation of the comments.

18. The method of claim 15 wherein the step of generating dialogue between first and second digital clones includes the additional step of evaluating the characteristics used to generate the first and second digital clones and generating dialogue between the first and second digital clones in response to the evaluation of the characteristics used to generate the first and second digital clones.

19. The method of claim 15 wherein the step of generating dialogue between first and second digital clones includes the additional step of matching the first and second digital clones randomly.

20. The method of claim 15 comprising the additional step of prompting at least one of the users of the first and second user devices to interject comments into the dialogue.

21. The method of claim 15 comprising the additional step of interjecting an advertisement into the dialogue between the first and second digital clones.

22. The method of claim 21 comprising the additional step of evaluating the characteristics used to generate the first and second digital clones to determine an interest of the users of the first and second user devices in the advertisement prior to interjecting the advertisement in the dialogue and modifying the advertisement in response to the evaluation of the characteristics.
